(19) United States
(12) Patent Application Publication
(10) Pub. No.: US 2010/0260958 A1
(43) Pub. Date: Oct. 14, 2010

(54) TONER CONTAINER AND IMAGE FORMING METHOD

(75) Inventors: Yasuko UCHINO, Tokyo (JP); Tomomi OSHIBA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/732,927

(22) Filed: Mar. 26, 2010

(30) Foreign Application Priority Data
Apr. 8, 2009 (JP) 2009093691

(51) Int. Cl. B29D 22/00

(52) U.S. Cl. 428/36.92; 264/572

(57) ABSTRACT

Provided is a toner container exhibiting reduced environmental load and excellent strength together with moldability obtained via a blow molding method, even though a large capacity of the toner container is produced, and also provided is an image forming method employing this toner container. Disclosed is a toner container of the present invention possessing a resin containing at least one of polyethylene and polypropylene formed from raw material prepared via a fermentation method.

This application claims priority from Japanese Patent Application No. 2009-093691 filed on Apr. 8, 2009, which is incorporated hereinto by reference.

### TECHNICAL FIELD

The present invention relates to a toner container and an image forming method employing the same.

### BACKGROUND

Toner consumption in image formation with a copying machine has recently been increased at high speed, when forming the images by an image forming method in an electrophotographic system. For this reason, the speed to supply the toner into a developing device is desired to be increased, whereby demanded is a larger capacity toner container to store the toner.

The toner container is preferably manufactured by a blow molding method, resulting in excellent moldability and preferable examples of resins employed to form the toner container include olefin based resins. Of these, polyethylene is more preferable, and high density polyethylene is still more preferable.

However, when the toner container is designed to be larger in capacity in the case of a toner container formed of such the olefin based resin, there appears a problem such that the olefin based resin exhibits inferior strength to that of a resin such as polycarbonate, an ABS resin or the like which generally exhibits high durability. In this case, it would appear that strength is increased by thickening a wall thickness of the toner container, but there is a problem such that in preparation via a blow molding method, it is difficult to thicken the wall thickness of the toner container in view of moldability.

Therefore, a plastic container exhibiting excellent strength together with moldability obtained via a blow molding method is disclosed in Patent Document 1, for example, when the container is formed of a resin containing high density polyethylene and straight-chain low density polyethylene.

On the other hand, as for increasing awareness of environmental protection, advanced are studies concerning a resin made of not raw material formed from petroleum but raw material formed from a plant or the like, that is, a non-petroleum-derived olefin based resin such as a polylactate or nonpetroleum-derived polyethylene, a nonpetroleum-derived polypropylene or the like.

(Patent Document 1) Japanese Patent O.P.I. Publication No. 2000-313425.

### SUMMARY

The present invention was made on the basis of the above-described situation. It is an object of the present invention to provide a toner container exhibiting reduced environmental load and excellent strength together with moldability obtained via a blow molding method, even though a large capacity of the toner container is produced, and also to provide an image forming method employing this toner container.

### BRIEF DESCRIPTION OF THE DRAWINGS

Embodiments will now be described, by way of example only, with reference to the accompanying drawing which is meant to be exemplary, not limiting, and wherein like elements numbered alike in the figure, in which:

FIG. 1 is an illustration schematic diagram showing an example of a toner container of the present invention.

### DESCRIPTION OF THE PREFERRED EMBODIMENTS

It is a feature that a toner container of the present invention comprising a resin comprising at least one of polyethylene and polypropylene formed from raw material prepared via a fermentation method is preferable. It is a feature that the above-described toner container, wherein the polyethylene has a melt index of 0.2-1.0 g/10 min, is preferable. It is a feature that the above-described toner container, wherein the polypropylene has a melt index of 0.8-3.0 g/10 min, is preferable. It is a feature that the above-described toner container, wherein the polyethylene has a density of 0.940-0.980 g/cm³, is preferable. It is a feature that the above-described toner container, wherein the polypropylene has a density of 0.890-0.950 g/cm³, is preferable. It is a feature that the above-described toner container preferably has a wall thickness of 0.5-5.0 mm. It is a feature that the above-described toner container preferably has a capacity of 1-10 L (liter). It is a feature that the above-described toner container is preferably a toner container having been molded via blow molding. It is a feature in the present invention that a method of manufacturing a toner container molded via blow molding preferably comprises the steps of placing a resin comprising at least one of polyethylene and polypropylene formed from raw material prepared via a fermentation method, in a molding die; blowing air into the resin placed in the molding die to closely attach the resin onto the molding die by inflating the resin; and cooling the resin closely attached onto the molding die. It is a feature that the above-described method, wherein the polyethylene has a melt index of 0.2-1.0 g/10 min, is preferable. It is a feature that the above-described method, wherein the polypropylene has a melt index of 0.8-3.0 g/10 min, is preferable. It is a feature that the above-described method, wherein the polyethylene has a density of 0.940-0.980 g/cm³, is preferable. It is a feature that the above-described method, wherein the polypropylene has a density of 0.890-0.950 g/cm³, is preferable. It is a feature that the above-described method, wherein the foregoing toner container has a wall thickness of 0.5-5.0 mm, is preferable. It is a feature that the above-described method, wherein the foregoing toner container has a capacity of 1-10 L.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

Next, the present invention will be described in detail.

[Toner container]

The toner container of the present invention is formed of a resin containing at least one of polyethylene formed from raw material obtained by a fermentation method (hereinafter, referred to also as “nonpetroleum-derived polyethylene”), and polypropylene formed from raw material obtained by a fermentation method (hereinafter, referred to also as “nonpetroleum-derived polypropylene”). As to a resin constituting the toner container of the present invention, a resin other than nonpetroleum-derived polyethylene and nonpetroleum-derived polypropylene may be contained in the toner container.

At least one of a nonpetroleum-derived polyethylene and a nonpetroleum-derived polypropylene, contained in the resin constituting the toner container of the present invention is formed from raw material obtained by a fermentation method. As the raw material obtained by the fermentation method, bioethanol is, for example, exemplified, and the bioethanol is produced via ethanol fermentation with yeasts by extracting saccharinity from botanical resources such as a corn and a sugarcane containing a large amount of sugar and starch, or cellulose or the like. Then, bioethanol is heated with an appropriate catalyst, and ethylene and water are prepared via dehydration reaction to obtain the nonpetroleum-derived polyethylene via polymerization of the resulting ethylene. Further, concerning the nonpetroleum-derived polypropylene, the bioethanol is produced similarly to the above-described, and propylene and water are prepared from this bioethanol to obtain the nonpetroleum-derived polypropylene via polymerization of the resulting propylene.

As to the resin constituting the toner container of the present invention, nonpetroleum-derived polyethylene preferably has a melt index (hereinafter, referred to also as “MI”) of 0.2-1.0 g/10 min, and more preferably has a melt index (hereinafter, referred to also as “MI”) of 0.2-0.6 g/10 min. Nonpetroleum-derived polypropylene preferably has a MI of 0.8-3.0 g/10 min, and more preferably has a MI of 0.8-2.5 g/10 min. However, in the case of an excessive amount of MI, moldability tends to be deteriorated since the wall thickness of the resulting toner container does not become even because of the resin exhibiting high fluidity. The MI is measured in accordance with ASTM D-1238 (nonpetroleum-derived polyethylene: 190° C./2.16 kg, and nonpetroleum-derived polypropylene: 230° C./2.16 kg), employing a melt indexer.

As to the resin constituting the toner container of the present invention, nonpetroleum-derived polyethylene preferably has a density of 0.940-0.980 g/cm³, and more preferably has a density of 0.943-0.968 g/cm³. Nonpetroleum-derived polypropylene preferably has a density of 0.890-0.950 g/cm³, and more preferably has a density of 0.890-0.920 g/cm³. When density falls within the above-described range, the resulting toner exhibits desired strength. The density is measured in accordance with ASTM D-792.

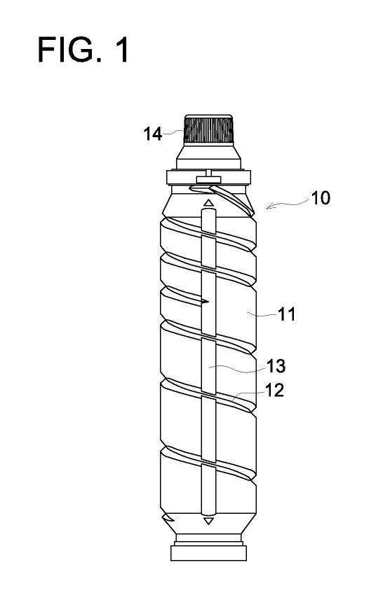

Shape of the toner container in the present invention is not specifically limited, but the shape as shown in FIG. 1 is provided. In FIG. 1, toner container 10 possesses helicoidally-shaped groove 12 provided on the outer circumferential surface of toner container main body 11 and straight groove 13 along a longitudinal direction of toner container main body 11, and this straight groove 13 and a protrusion portion provided in a toner container storage space of an image forming apparatus are fit, and installed in the image forming apparatus. Toner container 10 is installed in the toner container storage space in a state where cap 14 provided at the edge of toner container main body 11 is removed.

The toner container preferably has a wall thickness of 0.5-5.0 mm, and more preferably has a wall thickness of 0.5-4.0 mm. In the case of a toner container having a wall thickness exceeding 5.0 mm, the resulting toner container tends to have uneven wall thickness, and suffer poor moldability when the toner container is manufactured by a blow molding method. On the other hand, in the case of a toner container having a wall thickness of less than 0.5 mm, the resulting toner container tends not to secure desired strength.

Incidentally, capacity of the toner container is not specifically limited, but the toner container preferably has a capacity of 1-10 L (liter), and more preferably has a capacity of 2-8 L.

As the method of manufacturing a toner container of the present invention, the toner container is preferably manufactured by a blow molding method. The blow molding method is a molding method by which one in the form of a pipe obtained by melting a thermoplastic resin via heat, which is called parison, is extruded into a divided die, and a needle-shaped blowing air inlet is inserted into the inside of the parison after closing the die to blow air all at once. The harison is inflated by air pressure, pushed onto the die located outside, and solidified in the form of a hollow via cooling. Then, a product is taken out from the die by opening the die. In addition, in the present invention, in cases where a toner container molded via blow molding is manufactured, preferable is a method of manufacturing the toner container, comprising the steps of placing a resin comprising at least one of polyethylene and polypropylene formed from raw material prepared via a fermentation method, in a molding die; blowing air into the resin placed in the molding die to closely attach the resin onto the molding die by inflating the resin; and cooling the resin closely attached onto the molding die.

### [Toner]

Toners stored in the toner container of the present invention are not specifically limited, and those commonly known are usable.

In the present invention, a toner container exhibiting basically reduced environmental load and excellent strength together with moldability obtained via a blow molding method, even though a large capacity of the toner container can be produced when the toner container formed of a resin containing at least one of polyethylene and polypropylene formed from raw material prepared via a fermentation method, since a nonpetroleum-derived raw material prepared by a fermentation method, by which a plant or the like is fermented, is employed as the raw material for the resin constituting the toner container.

### Example

Next, specific examples of the present invention will be described, but the present invention is not limited thereto.

### Example 1

Nonpetroleum-derived polyethylene [1] formed from bioethanol as raw material obtained by the above-described fermentation method was prepared, and toner container [1] shown in FIG. 1 was prepared via a blow molding method by using a resin nonpetroleum-derived polyethylene [1] content of 100% by weight, a MI of 0.35 g/10 min, and a density of 0.957 g/cm³. Toner container [1] had a wall thickness of 2.1 mm. In toner container [1], stored were 100 g of toner, and the dropping test described below was conducted to evaluate dropping strength. The results are shown in Table 1.

### [Dropping Test]

As to the dropping test, both ends of a toner container were held in both hands, and 20 times of dropping from a 1.5 m high point to a concrete floor were done to visually observe presence or absence of appearance change (such as cracks, damage, dent or the like) of the toner container. It is decided that there is no practical problem if no change can be confirmed at a time when 10 times of dropping are completed.

### Example 2

Toner container [2] was prepared similarly to preparation of Example 1, except that nonpetroleum-derived polyethylene [1] was replaced by nonpetroleum-derived polypropylene [2] formed from bioethanol as raw material obtained by a fermentation method. Toner container [2] had a wall thickness of 1.9 mm. Further, dropping strength was evaluated similarly to Example 1. The results are shown in Table 1.

### Comparative Example 1

Comparative toner container [1] was prepared similarly to preparation of Example 1, except that nonpetroleum-derived polyethylene [1] was replaced by petroleum-derived polyethylene [1] formed from petroleum as raw material. Comparative toner container [1] had a wall thickness of 2.0 mm. Further, dropping strength was evaluated similarly to Example 1. The results are shown in Table 1.

TABLE 1

| | Toner | Resin | | | Content | |
|---|---|---|---|---|---|---|
| | container | | MI | Density | (% by | |
| | No. | Kinds | (g/10 min) | (g/cm³) | weight) | Evaluation |
| Ex. 1 | Toner | Nonpetroleum- | 0.35 | 0.957 | 100 | No |
| | container | derived | (190° C.) | | | problem |
| | [1] | polyethylene | | | | |
| | | [1] | | | | |
| Ex. 2 | Toner | Nonpetroleum- | 1.51 | 0.907 | 100 | No |
| | container | derived | (230° C.) | | | problem |
| | [2] | polypropylene | | | | |
| | | [2] | | | | |
| Comp. 1 | Comparative | Petroleum- | 0.35 | 0.951 | 100 | Cracks |
| | toner | derived | (190° C.) | | | observed |
| | container | polyethylene | | | | on the |
| | [1] | [1] | | | | 8^{th} time |
| | | | | | | of dropping |

Ex.: Example,
Comp.: Comparative example

As is clear from Examples 1 and 2 of the present invention, it was confirmed that toner containers exhibiting excellent strength were able to be obtained.

### Effect of the Invention

In the present invention, a toner container exhibiting basically reduced environmental load and excellent strength together with moldability obtained via a blow molding method, even though a large capacity of the toner container can be produced when the toner container formed of a resin containing at least one of polyethylene and polypropylene formed from raw material prepared via a fermentation method, since a nonpetroleum-derived raw material prepared by a fermentation method, by which a plant or the like is fermented, is employed as the raw material for the resin constituting the toner container. The reason why the toner container of the present invention exhibits excellent strength is not clear, but it is assumed that a polyethylene resin and a polypropylene resin formed from raw material prepared via a fermentation method has lower concentration of impurities contained in the resin than that of polyethylene formed from petroleum-derived raw material. That is, since as to polyethylene or polypropylene contained in the resin constituting the toner container of the present invention, ethylene or propylene as a raw material monomer of the polyethylene or polypropylene is produced from nonpetroleum-derived ethanol formed from a plant, the reason is presumably that the polyethylene or the polypropylene exhibits lower concentration of impurities than that of ethylene or propylene obtained by thermally decomposing naphtha prepared via fractional distillation of crude oil. Kinds and a content thereof of impurities contained in nonpetroleum-derived ethylene or nonpetroleum-derived propylene are presumably different from those of impurities contained in petroleum-derived ethylene or petroleum-derived propylene. Since these impurities remain in the polymer resin even after conducting a polymerization process by which a polymer is obtained via polymerization of ethylene or propylene, it is assumed that cracks and appearance change, caused by generation of disorder in crystallization of the resin are produced in the case of a process of molding this resin to produce a toner container. On the other hand, in cases where the toner container is formed of the resin prepared from raw material obtained via a fermentation method, there is no problem like this, and the resin property becomes even when blow molding a container in large capacity, whereby the toner container exhibits excellent strength.

Further, an image forming method to basically reduce an environmental load can be provided by utilizing the above-described toner container according to the present invention.

What is claimed is:

1. A toner container comprising a resin comprising at least one of polyethylene and polypropylene formed from raw material prepared via a fermentation method.

2. The toner container of claim 1,
wherein the polyethylene has a melt index of 0.2-1.0 g/10 min.

3. The toner container of claim 1,
wherein the polypropylene has a melt index of 0.8-3.0 g/10 min.

4. The toner container of claim 1,
wherein the polyethylene has a density of 0.940-0.980 g/cm³.

5. The toner container of claim 1,
wherein the polypropylene has a density of 0.890-0.950 g/cm³.

6. The toner container of claim 1, having a wall thickness of 0.5-5.0 mm.

7. The toner container of claim 1, having a capacity of 1-10 L.

8. The toner container of claim 1, being a toner container having been molded via blow molding.

9. A method of manufacturing a toner container molded via blow molding, comprising the steps of:
(a) placing a resin comprising at least one of polyethylene and polypropylene formed from raw material prepared via a fermentation method, in a molding die,
(b) blowing air into the resin placed in the molding die to closely attach the resin onto the molding die by inflating the resin, and
(c) cooling the resin closely attached onto the molding die.

10. The method of claim 9,
wherein the polyethylene has a melt index of 0.2-1.0 g/10 min.

11. The method of claim 9,
wherein the polypropylene has a melt index of 0.8-3.0 g/10 min.

12. The method of claim 9,
wherein the polyethylene has a density of 0.940-0.980 g/cm³.

13. The method of claim 9,
wherein the polypropylene has a density of 0.890-0.950 g/cm³.

14. The method of claim 9,
wherein the toner container has a wall thickness of 0.5-5.0 mm.

15. The method of claim 9,
wherein the toner container has a capacity of 1-10 L.
